(19) United States
(12) Patent Application Publication
(10) Pub. No.: US 2014/0351284 A1
(43) Pub. Date: Nov. 27, 2014

(54) SYSTEM FOR PERFORMING A PERSONALIZED INFORMATION SEARCH

(71) Applicant: Artashes Valeryevich Ikonomov, Moscow (RU)

(72) Inventor: Artashes Valeryevich Ikonomov, Moscow (RU)

(21) Appl. No.: 14/363,362

(22) PCT Filed: Aug. 27, 2013
(86) PCT No.: PCT/RU2013/000743

§ 371 Date: Jun. 6, 2014

(30) Foreign Application Priority Data
Sep. 12, 2012 (RU) 2012139058

(51) Int. Cl. G06F 17/30

(52) U.S. Cl. CPC G06F 17/30522; G06F 17/30545; G06F 17/30277
USPC 707/770

(57) ABSTRACT

The invention relates to systems for performing a personalized information search, which systems comprise client devices of remote users, and includes a query generation module, a data display module, and a module for determining the location of a client device, wherein the client devices are connected to one another with the aid of a combined network, which comprises at least one server comprising a module for processing and selecting data on the basis of a user query, a personalization module which is connected to the module for processing and selecting data on the basis of a user query, and a database storage module which is connected to the module for processing and selecting data on the basis of a user query and to the personalization module. The server comprises a module for 3D navigation and movements around a virtual world, and a module for controlling a cartographic system. The data display module comprises a module for displaying data of the virtual world and a module for displaying query results. The technical result consists in extending the possibilities of a system for performing a personalized information search.

The invention relates to systems for performing an information search with the help of computer means and especially to systems for performing a personalized information search comprising client devices of remote users, and including a query generation module, a data display module, and a module for determining the location of a client device, the client devices being connected to one another with the help of a combined network, which includes at least one server comprising a module for processing and selecting data on the basis of a user query, a personalization module connected to the module for processing and selecting data on the basis of a user query, and a database storage module connected to the module for processing and selecting data on the basis of a user query and to the personalization module, said system can be used in computer-based communication systems, for example, in social networks.

Known prior art includes systems for performing a personalized information search which rely on personalized user data in addition to the user query for more accurate search results.

A known example of prior art is a system for performing a personalized information search comprising client devices of remote users including a query generation module, a data display module, the client devices being connected to one another with the help of a combined network including at least one server comprising a module for processing and selecting data on the basis of a user query, a personalization module connected to the module for processing and selecting data on the basis of a user query, a database storage module connected to the module for processing and selecting data on the basis of a user query and to the personalization module, as described in the Russian invention patent No 2324220, published in 2006.

In this system a multitude of individual clients is communicatively connected to the server with the help of a combined network such as the Internet, said server comprises an attached storage device which stores the web content, the module for processing and selecting data on the basis of a user query being executed as a server-based search engine, the personalization module being executed as a means for extension of one of the search terms based on at least one user-defined operator.

The drawback of the system is that it does not allow to incorporate the user's location in the virtual world in the search or to visualize the user from among the objects which are virtual items and a query response result, thus that limiting the use of such system.

Another example of prior art is a system for performing a personalized information search, comprising client devices of remote users which include a query generation module, a data display module, and a module for determining the location of a client device, the client devices being connected to one another with the help of a combined network, which includes at least one server comprising a module for processing and selecting data on the basis of a user query, a personalization module connected to the module for processing and selecting data on the basis of a user query, a database storage module connected to the module for processing and selecting data on the basis of a user query and to the personalization module, as described in the Russian invention patent No 2419858, published in 2007.

This system employs a user interface for search query registration and search result display as a query generation module and a data display module; a computer-based data medium is used as a database storage module. A personalization component related to the user model for information retrieval based on the user query and specific user features and a component for parameters controlling the user model data set are used as a personalization module.

The above device is used herein as a prototype of the invention claimed.

The known solution has a drawback, namely that it does not allow to incorporate the user's location in the virtual world in the search, to visualize the user from among the objects which are virtual items and a user's query response result, thus that limiting the use of such system.

The present invention relies on this novel observation with the primary aim to offer a system for performing a personalized information search that serves at least to mitigate the aforementioned drawback, namely, to incorporate the user's location in the virtual world in the search and to visualize the search results, thereby extending the possibilities of the system.

For this purpose, the server includes a module for 3D navigation and movements around a virtual world, and a module for controlling a cartographic system, whereas the database storage module includes a personal information database storage unit, an actual and a virtual map database storage unit, a static and dynamic object database storage unit; whereas the data display module includes a module for displaying data of the virtual world and a module for displaying query results.

The above makes it possible to incorporate the user's location in the virtual world in the search by virtue of the module for 3D navigation and movements around a virtual world. The module for displaying data of the virtual world and the module for displaying query results allow to visualize the user from among the objects which are virtual items and a user's query response result. The personal information database storage unit, the actual and virtual map database storage unit, the static and dynamic object database storage unit enable storage of the information on the virtual world objects.

There is a version of the invention in which the module for 3D navigation and movements around a virtual world is connected to the module for determining the location of a client device, the static and dynamic object database storage unit, the actual and virtual map database storage unit, the module for controlling a cartographic system and a query generation module. The module for controlling a cartographic system is connected to the query generation module, the actual and virtual map database storage unit and the module for 3D navigation and movements around a virtual world. The personal information database storage unit is connected to the query generation module and the personalization module. The actual and virtual map database storage unit is connected to the module for controlling a cartographic system, the data display module and the module for 3D navigation and movements around a virtual world. The static and dynamic object database storage unit is connected to the module for 3D navigation and movements around a virtual world, the data display module, the module for determining the location of a client device and the module for processing and selecting data on the basis of a user query. The module for displaying data of the virtual world is connected to the module for displaying query results, the actual and virtual map database storage unit and the static and dynamic object database storage unit. The module for displaying query results is connected to the module for displaying data of the virtual world and the module for processing and selecting data on the basis of a user query.

The above makes it possible to ensure optimum operation of the system for performing a personalized information search.

The combination of the essential features of the claimed invention is not known from the prior art, therefore the invention possesses the required feature of novelty.

Other distinguishing features and advantages of the invention are readily apparent from the description below which includes but is not limited to the following features, with reference to the figure attached:

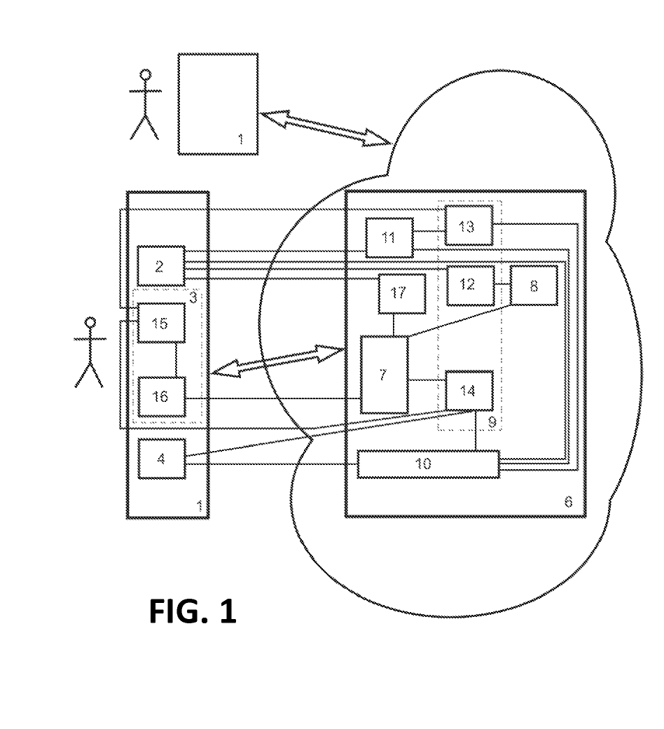

FIG. 1 is a layout representation of the flowchart of the system for performing a personalized information search according to the invention.

The system for performing a personalized information search comprises (see FIG. 1) client devices 1 of remote users including a query generation module 2, a data display module 3, a module for determining the location of a client device 4, said client devices 1 being connected to one another with the help of a combined network 5, which includes at least one server 6 comprising a module for processing and selecting data on the basis of a user query 7, a personalization module 8 connected to a module for processing and selecting data on the basis of a user query 7, a database storage module 9 connected to a module for processing and selecting data on the basis of a user query 7 and to the personalization module 8. The server 6 includes a module for 3D navigation and movements around a virtual world 10, a module for controlling a cartographic system 11. The database storage module 9 includes a personal information database storage unit 12, an actual and virtual map database storage unit 13, a static and dynamic object database storage unit 14. The data display module 3 includes a module for displaying data of the virtual world 15 and a module for displaying query results 16.

The module for 3D navigation and movements around a virtual world 10 is connected to the module for determining the location of a client device 4, the static and dynamic object database storage unit 14, the actual and virtual map database storage unit 13, the module for controlling a cartographic system 11 and the query generation module 2. The module for controlling a cartographic system 11 is connected to the query generation module 2, the actual and virtual map database storage unit 13 and the module for 3D navigation and movements around a virtual world 10. The personal information database storage unit 12 is connected to the query generation module 2 and the personalization module 8. The actual and virtual map database storage unit 13 is connected to the module for controlling a cartographic system 11, the data display module 3 and the module for 3D navigation and movements around a virtual world 10. The static and dynamic object database storage unit 14 is connected to the module for 3D navigation and movements around a virtual world 10, the module for displaying data of the virtual world 15, the module for determining the location of a client device 4 and the module for processing and selecting data on the basis of a user query 7. The module for displaying data of the virtual world 15 is connected to the module for displaying query results 16, the actual and virtual map database storage unit 13 and the static and dynamic object database storage unit 14. The module for displaying query results 16 is connected to the module for displaying data of the virtual world 15 and the module for processing and selecting data on the basis of a user query 7.

The system includes an additional query form generation module 17 connected to the query generation module 2 and the module for processing and selecting data on the basis of a user query 7.

The query generation module 2 is a means to provide the user with the option to form a query in the system to enable personalized information search.

The personalization module 8 is used to define a context of the query.

The query form generation module 17 is used to generate an immediate query form once the context is defined.

The module for controlling a cartographic system 11 is included to support the system operation and to enable personalized information search with actual and virtual maps and diagrams.

The module for displaying data of the virtual world 15 is required to display maps and specified objects in the system for performing personalized information search.

The module for determining the location of a client device 4 is designed to support and register actual location of the system users to enable personalized information search.

The module for processing and selecting data on the basis of a user query 7 serves to select a multitude of objects matching the specified criteria.

The module for 3D navigation and movements around a virtual world 10 is designed to enable movement in 3D models of actual and virtual worlds of the system to perform personalized information search.

In general, any variety of computing platforms that can be connected to a network such as a combined network and can interact with applications can be a client device 1. Standard examples of some such client devices include but are not limited to desktop and laptop personal computers, smart cellular phones (smartphones), lightweight clients, workstations, “non-intelligent” terminals connected to the application server and various combinations and configurations of the same that are self-evident for those skilled in the art, i.e. these include both physical devices that ensure interaction as part of communication and virtual devices based on programmable computers and having program interface to enable such communication.

The combined network 5 and all connections between all modules and units comprise a multitude of topologies, configurations and arrangements of the internetworking components built so as to connect corporate, global and local computer networks. Such network includes but is not limited to traditional wired and wireless, satellite, optical and equivalent networking technology that are self-evident for those skilled in the art.

The system for performing personalized information search operates as follows.

The user employs a client device 1 to connect to the server 6 via the combined network 5.

The user can utilize the client device to send an electric signal to the query generation module 2. The query generation module 2 selects a personal information from the personal information database located in the personal information database storage unit 12. The personalization module 8 analyzes the user's personal information, i.e. his/her current location (currently active page and its content), route to the current page starting from the moment of system access, current geographical position of the user (if registered by the system). In addition, the query generation module 2 provides an option for selection of a search category.

The search context is defined by way of information analysis and registration and is used to generate a required form where query categories and criteria are recorded by the query form generation module 17.

The query categories may include the following:

1. System users sorted by subcategories (friends, relatives, coworkers, by gender, etc, in general, by the user-provided registration and descriptive information).

2. Countries, localities (actual or virtual) with their maps and diagrams.

3. Static objects (business objects, transport objects, objects of historical and cultural heritage and others).

4. Dynamic objects (system clients) with automatic fixation of their location.

The query criteria include specific characteristics related to this or that category: for users—age and age range, gender, preferences, biometrical parameters and range of the same, etc; for business objects—scope of activity; for museums—their specialization, etc.

The search procedure based on query form filling is directly performed by the module for processing and selecting data on the basis of a user query 7. The query parameters and the coded search result form are transmitted by electric signals to the personal information database storage unit 12 and saved in the personal information database as data.

As soon as the personal information is saved, the module for processing and selecting data on the basis of a user query 7 transmits electric signals corresponding to the search results based on the query to the module for displaying query results 16; said module defines the structure and form of the query results display and transfers the batch containing the query results data, the structure descriptors and the query result display forms to the multi-purpose data display module 3.

The data display module 3 forms an image based on the context, data structure descriptors and data positioning forms on the screen of the user's client device 1. For this purpose, the image-generating signals are subdivided into static and dynamic and are selected by means of signals from the static and dynamic object database storage unit 14 and the actual and virtual map database storage unit 13

Graphic images of actual and virtual maps are generated both as static raster images and images based on vector descriptions of geographic maps on the screen of the user's client device 1. If the query requires that static and/or dynamic objects be displayed on the maps, the module for displaying query results 16 positions images of such data on the maps and diagrams.

The module for 3D navigation and movements around a virtual world 10 performs 3D imaging of the localities landscapes including images of the buildings, greenery and other elements wherein the user is physically or virtually present. The module for 3D navigation and movements around a virtual world 10 enables the user to move around the locality, view the objects and other elements incorporated in the 3D model based on the dynamic data selected in accordance with the user's query. For example, if the query sets a criterion for selection of specific category of books, and the user is in a virtual library or a virtual bookshop, the system will display covers of the books retrieved in accordance with the query on the library or bookshop shelves. The positioning data of the movements around the 3D model of the locality are registered in the static and dynamic object database by transmitting an electric signal to the module for determining the location of a client device 4 regardless of whether the client location data are sent by the user's client devices 1.

The module for determining the location of a client device 4 functions as both a background receiver of the client positioning data transmitted from the client devices, e.g. mobile devices, based on applicable standards, and as a receiver of positioning data from the module for 3D navigation and movements around a virtual world 10 by synchronous calls. Having received the positioning data, the module for determining the location of a client device 4 sends a signal to the static and dynamic object database storage unit 14 representing notes on the types of positioning data received. The above serves to synchronize the positioning data received from the user's client device and the module for 3D navigation and movements around a virtual world 10. The user's physical and virtual positioning data may differ, or a set of positioning data can be ignored.

The module for controlling a cartographic system 11 systemizes and stores the maps, as well as selects and presents them in a required form based on a request from the social network services.

A system for performing a personalized information search in the environment of the Cafe4tune social network has been made in accordance with the claimed invention. Trial runs of said system for performing a personalized information search demonstrated that said system is capable of:
incorporating the user's location in the virtual world in the search,
incorporating the following in the search:

1) user address attributes defined by the social network users during registration and creation of virtual likenesses;

2) current user positioning data determined by the positioning services of mobile devices and other client devices;

3) a set of actual geographic maps and diagrams of virtual cities and countries;

4) matching of a total range of static objects (museums, stores, fuel stations, companies, etc) to the actual geographic maps and diagrams of virtual cities and countries;

5) a diverse range of relationships created by the users in a social network, i.e. “friend”, “relative”, “colleague”, “classmate”, “schoolmate”, etc.
visualizing the search results for the user,
visualizing the user from among the search results in a virtual world.

The above features ultimately expand the system capabilities for performing personalized information search.

1. System for performing a personalized information search, comprising client devices of remote users which include:
a query generation module,
a data display module, and
a module for determining the location of a client device,
the client devices being connected to one another with the help of a combined network, which includes at least one server comprising:
a module for processing and selecting data on the basis of a user query,
a personalization module connected to the module for processing and selecting data on the basis of a user query,
a database storage module connected to the module for processing and selecting data on the basis of a user query and to the personalization module,
wherein said server includes:
a module for 3D three-dimensional navigation and movements around a virtual world,
a module for controlling a cartographic system,
wherein said database storage module includes:
a personal information database storage unit,
an actual and virtual map database storage unit,
a static and dynamic objects database storage unit, and
wherein the data display module includes:
a module for displaying data of the virtual world and
a module for displaying query results.

2. System for performing a personalized information search according to the claim 1, wherein said module for three-dimensional navigation and movements around a virtual world is connected to:
the module for determining the location of a client device,
the static and dynamic objects database storage unit,
the actual and virtual map database storage unit,
the module for controlling a cartographic system and the query generation module,
wherein said module for controlling a cartographic system is connected to:
the query generation module,
the actual and virtual map database storage unit and
the module for three-dimensional navigation and movements around a virtual world,
wherein said personal information database storage unit is connected to:
the query generation module and
the personalization module,
wherein the actual and virtual map database storage unit is connected to:
the module for controlling a cartographic system,
the data display module and
the module for three-dimensional navigation and movements around a virtual world,
wherein the static and dynamic objects database storage unit is connected to:
the module for three-dimensional navigation and movements around a virtual world,
the module for displaying data of the virtual world,
the module for determining the location of a client device and
the module for processing and selecting data on the basis of a user query,
wherein the module for displaying data of the virtual world is connected to:
the module for displaying query results,
the actual and virtual map database storage unit and
the static and dynamic objects database storage unit, and
wherein the module for displaying query results is connected to:
the module for displaying data of the virtual world and
the module for processing and selecting data on the basis of a user query.

3. System for performing a personalized information search according to the claim 2, wherein the system includes an additional query form generation module connected to the query generation module and the module for processing and selecting data on the basis of a user query.

4. System for performing a personalized information search according to the claim 3, wherein the query generation module is adapted to form a query in the system to enable personalized information search.

5. System for performing a personalized information search according to the claim 4, wherein the personalization module is adapted to define a context of the query.

6. System for performing a personalized information search according to the claim 5, wherein the query form generation module is adapted to generate an immediate query form once the context is defined.

7. System for performing a personalized information search according to the claim 6, wherein the module for controlling a cartographic system is adapted to enable personalized information search with actual and virtual maps and diagrams.

8. System for performing a personalized information search according to the claim 7, wherein the module for displaying data of the virtual world is adapted to display maps and specified objects.

9. System for performing a personalized information search according to the claim 8, wherein the module for determining the location of a client device is adapted to support and register actual location of the system users.

10. System for performing a personalized information search according to the claim 9, wherein the module for processing and selecting data on the basis of a user query is adapted to select a multitude of objects matching the specified criteria.

11. System for performing a personalized information search according to the claim 10, wherein the module for three-dimensional navigation and movements around a virtual world is adapted to enable movement in three-dimensional models of actual and virtual worlds.

12. System for performing a personalized information search according to the claim 11, wherein the module for controlling a cartographic system is also adapted to systemize and store the maps, as well as to select and present them in a required form based on a request from social network services.

13. Method of operation of a system for performing a personalized information search, said system is adapted to be functioned in a social network and comprises client devices of remote users which include:
a query generation module,
a data display module, and
a module for determining the location of a client device,
the client devices being connected to one another with the help of a combined network, which includes at least one server comprising:
a module for processing and selecting data on the basis of a user query,
a personalization module connected to the module for processing and selecting data on the basis of a user query,
a database storage module connected to the module for processing and selecting data on the basis of a user query and to the personalization module,
wherein said server includes:
a module for three-dimensional navigation and movements around a virtual world,
a module for controlling a cartographic system,
wherein said database storage module includes:
a personal information database storage unit,
an actual and virtual map database storage unit,
a static and dynamic objects database storage unit,
wherein the data display module includes:
a module for displaying data of the virtual world and
a module for displaying query results, and
wherein the method of operation comprises:
connecting the client device to the server via the combined network,
sending an electric signal from the client device to the query generation module,
selecting with the help of the query generation module a personal information from the personal information database, the personal information database being located in the personal information database storage unit,
analyzing of the user's personal information with the help of the personalization module,
performing a search procedure with the help of the module for processing and selecting data on the basis of a user query,
transmitting electric signals with the help of the module for processing and selecting data on the basis of a user query to the module for displaying query results, the module for displaying query results being adapted:
to define the structure and form of the query results display and
to transfer a batch containing the query results data, the structure descriptors and the query result display forms to the multi-purpose data display module,
forming an image based on the context, data structure descriptors and data positioning forms on the screen of the client device with the help of image-generating signals emitted by the data display module, such image-generating signals being subdivided into static and dynamic and being selected by means of signals from the static and dynamic object database storage unit and the actual and virtual map database storage unit.

14. Method of operation according to claim 13, wherein the module for three-dimensional navigation and movements around a virtual world is connected to:
the module for determining the location of a client device,
the static and dynamic objects database storage unit,
the actual and virtual map database storage unit,
the module for controlling a cartographic system and the query generation module,
wherein said module for controlling a cartographic system is connected to:
the query generation module,
the actual and virtual map database storage unit and
the module for three-dimensional navigation and movements around a virtual world,
wherein said personal information database storage unit is connected to:
the query generation module and
the personalization module,
wherein the actual and virtual map database storage unit is connected to:
the module for controlling a cartographic system,
the data display module and
the module for three-dimensional navigation and movements around a virtual world,
wherein the static and dynamic objects database storage unit is connected to:
the module for three-dimensional navigation and movements around a virtual world,
the module for displaying data of the virtual world,
the module for determining the location of a client device and
the module for processing and selecting data on the basis of a user query,
wherein the module for displaying data of the virtual world is connected to:
the module for displaying query results,
the actual and virtual map database storage unit and
the static and dynamic objects database storage unit,
wherein the module for displaying query results is connected to:
the module for displaying data of the virtual world and
the module for processing and selecting data on the basis of a user query, and the method of operation comprises:
performing a three-dimensional model of the locality of actual or virtual worlds with the help of the module for three-dimensional navigation and movements around a virtual world,
moving around the three-dimensional model of the locality with the help of the module for three-dimensional navigation and movements around a virtual world.

15. Method of operation according to claim 14, wherein the module for determining the location of a client device is adapted to function as both a background receiver of the client positioning data transmitted from the client devices and as a receiver of positioning data from the module for three-dimensional navigation and movements around a virtual world by synchronous calls, and wherein the method of operation comprises:
registering in the static and dynamic object database of the positioning data of the movements around the three-dimensional model of the locality by transmitting an electric signal to the module for determining the location of a client device regardless of whether the client location data are sent by the client devices,
sending a signal representing notes on the types of positioning data received from the module for determining the location of a client device to the static and dynamic object database storage unit,
synchronizing the positioning data received from the client device and the module for three-dimensional navigation and movements around a virtual world.

16. Method of operation according to claim 15, wherein the method comprises:
generating on the screen of the client device the graphic images of actual and virtual maps both as static raster images and images based on vector descriptions of geographic maps,
if the query requires that static and/or dynamic objects be displayed on the maps, positioning the images of such data on the maps and diagrams with the help of the module for displaying query results.

17. Method of operation according to claim 16, wherein the system for performing a personalized information search includes an additional query form generation module connected to the query generation module and the module for processing and selecting data on the basis of a user query, and wherein the method of operation comprises:
defining the search context by way of information analysis and registration,
generating a required form where query categories and query criteria are recorded by the query form generation module, the query categories including at least one of the following: (a) system users sorted by subcategories; (b) actual or virtual localities with their maps and diagrams; (c) countries with their maps and diagrams; (d) static objects; (e) dynamic objects with automatic fixation of their location, the query criteria including specific characteristics related to this or that category.

18. Method of operation according to claim 17, wherein the method comprises:
transmitting of the query parameters and the coded search result form by electric signals to the personal information database storage unit,
saving of the query parameters and the coded search result form in the personal information database as data.
